(19) United States
(12) Patent Application Publication
(10) Pub. No.: US 2026/0309338 A1
(43) Pub. Date: Oct. 8, 2026

(54) HEATING COOKER

(71) Applicant: SHARP KABUSHIKI KAISHA, Osaka (JP)

(72) Inventor: Shigenori MORIMOTO, Osaka (JP)

(21) Appl. No.: 19/633,695

(22) Filed: Mar. 30, 2026

(30) Foreign Application Priority Data
Apr. 3, 2025 (JP) 2025-061593

(51) Int. Cl. F24C 15/02; E05B 47/00; F24C 7/06

(52) U.S. Cl. CPC F24C 15/022; F24C 7/067; E05B 2047/0017; E05B 2047/0024

(57) ABSTRACT

A heating cooker includes: a main body portion; a door portion having a door hook; and a lock mechanism including a lock lever member that rotates about a fulcrum with rotation of a cam, in which the lock lever member includes: a first portion extending in a direction away from the fulcrum and provided with an engagement portion that engages with the door hook; and a second portion extending in a direction away from the fulcrum and provided at a position in a second direction opposite to the first direction with respect to the first portion, and when the lock lever member rotates in the first direction from a locked state where the engagement portion engages with the door hook, the first portion moves in a direction away from the door hook to release the locked state, and the second portion comes into contact with the door hook to push out the door portion in an opening direction.

### BACKGROUND OF THE INVENTION

### 1. Technical Field

The present disclosure relates to a heating cooker and the like.

### 2. Description of the Related Art

Conventionally, a heating cooker that locks a door of a heating chamber and automatically opens the door is known (for example, JP H07-12805 U).

### SUMMARY

In JP H07-12805 U, a locking body that holds a door in a locked state and a spring member that biases the door in an opening direction are provided as different members.

According to some aspects of the present disclosure, it is possible to provide a heating cooker that switches a locked state of a door and performs a door opening operation with a simple configuration.

An aspect of the present disclosure relates to a heating cooker including: a main body portion; a door portion having a door hook and being movable with respect to the main body portion; and a lock mechanism including a cam, a motor that rotates the cam, and a lock lever member that rotates in a first direction about a fulcrum with rotation of the cam, in which the lock lever member includes: a first portion extending in a direction away from the fulcrum and provided with an engagement portion that engages with the door hook; and a second portion extending in a direction away from the fulcrum and provided at a position in a second direction opposite to the first direction with respect to the first portion, and when the lock lever member rotates in the first direction from a locked state where the engagement portion engages with the door hook, the first portion moves in a direction away from the door hook to release the locked state, and the second portion comes into contact with the door hook to push out the door portion in an opening direction.

### BRIEF DESCRIPTION OF THE DRAWINGS

FIG. 1 is a diagram illustrating a configuration example of a heating cooker;

FIG. 2 is a diagram illustrating a configuration example of the heating cooker;

FIG. 3 is a diagram illustrating a configuration example of a lock mechanism;

FIG. 4 is a diagram illustrating a configuration example of the lock mechanism;

FIG. 5 is a diagram illustrating a configuration example of the lock mechanism;

FIG. 6 is a diagram illustrating a configuration example of the lock mechanism;

FIG. 7 is a timing chart illustrating a flow of operation of each unit of the heating cooker; and

FIG. 8 is a timing chart for explaining a flow of operations of a motor and a cam phase detection switch.

### DETAILED DESCRIPTION

Hereinafter, the present embodiment will be described with reference to the drawings. In the drawings, the same or equivalent elements are denoted by the same reference numerals, and redundant description is omitted. Note that the present embodiment described below does not unreasonably limit the contents described in the claims. In addition, not all the configurations described in the present embodiment are essential constituent elements of the present disclosure.

### 1. HEATING COOKER

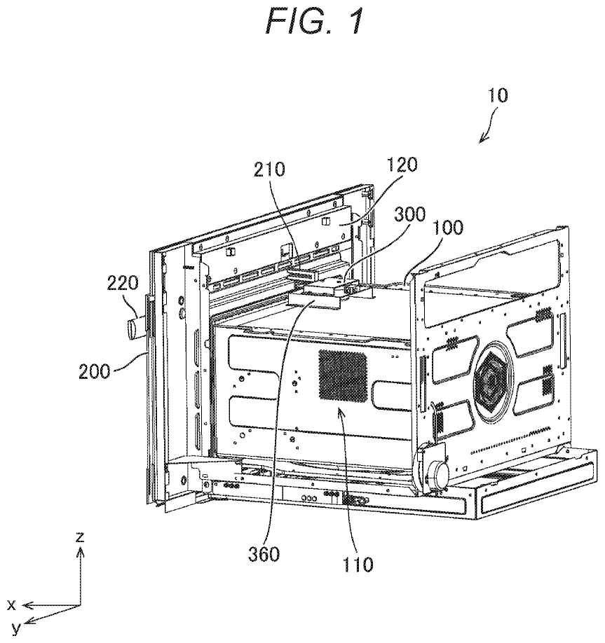

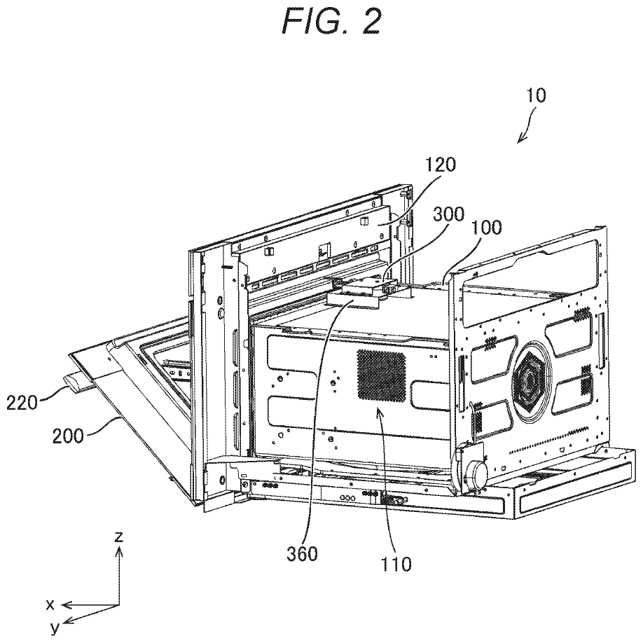

A configuration of a heating cooker 10 according to the present embodiment will be described with reference to FIGS. 1 and 2. FIG. 1 is a view illustrating a configuration example of the heating cooker 10 in which a door portion 200 described later is in a closed state, and FIG. 2 is a view illustrating a configuration example of the heating cooker 10 in a state where the door portion 200 shifts from the closed state to the open state. In FIGS. 1 and 2, illustration of a partial structure of a housing (cabinet) of the heating cooker 10 is omitted.

The heating cooker 10 according to the present embodiment heats, for example, a food, a food product, a beverage, or various other objects to be heated. The heating cooker 10 heats an object to be heated by circulating a heated airflow inside a heating compartment 110 like an oven, for example. The heating compartment 110 has a hollow rectangular parallelepiped shape and is configured to be capable of accommodating an object to be heated. In FIGS. 1 and 2, an outer wall of the heating compartment 110 is illustrated. Note that the heating cooker 10 may have a grill function, a steam function of heating with water vapor, or the like, or may have a function of irradiating an object to be heated in the heating compartment 110 with an electromagnetic wave to heat the object to be heated, like a microwave oven.

The heating cooker 10 is, for example, an electric device that operates by receiving power supply from a power system (AC power supply). That is, the heating cooker 10 operates so as to drive a heat source (not illustrated) by receiving power supply, heat the airflow by the driven heat source, and heat the object to be heated by circulating the heated airflow inside the heating compartment 110.

The heating cooker 10 is used in a state of being placed on an installation surface including, for example, a shelf of a house, a counter, or the like. The heating cooker 10 according to the present embodiment is a self-standing and portable device, and a user can install the heating cooker 10 at an arbitrary position on the installation surface. Note that the heating cooker 10 may be used in a state of being fixed to a specific place such as a counter in a kitchen, for example.

In the present embodiment, for convenience of description, an up-down direction which is a vertical direction in a state where the heating cooker 10 can be used is defined as a z-axis, and an upward direction is defined as a z-axis positive direction. Further, with reference to a direction in which the heating cooker 10 is viewed from the front, a left-right direction is defined as a y-axis, and a right direction is defined as a y-axis positive direction. A front-rear direction in which a front side of the heating cooker 10 is a front side and a back side is a rear side is defined as an x-axis, and a front direction is defined as an x-axis positive direction. However, these directions are not intended to limit the use direction (direction at the time of use) of the heating cooker 10.

As illustrated in FIGS. 1 and 2, the heating cooker 10 includes a main body portion 100 (box) including the heating compartment 110 and the door portion 200 (door). For example, the heating compartment 110 is formed in a box shape with one surface opened. The door portion 200 is attached to the main body portion 100 in a state where an opening surface of the heating compartment 110 can be opened and closed. In the example of the present embodiment, the opening surface of the heating compartment 110 is a front surface.

The door portion 200 is supported to be openable and closable with respect to the main body portion 100 by a support part (hinge) provided at a lower portion on the front surface side of the main body portion 100. The door portion 200 rises to the far side to be in the closed position, and the upper part falls forward to be shifted to the open position. Hereinafter, a state in the middle is illustrated. The door portion 200 has a handle 220 that can be gripped by a user.

As illustrated in FIG. 2, when the door portion 200 is in the open state, the inside of the heating compartment 110 is exposed from the front surface of the main body portion 100, so that the object to be heated can be put in and out of the heating compartment 110. On the other hand, when the door portion 200 is in the closed state (closed position), the inside of the heating compartment 110 is sealed, so that the object to be heated accommodated in the heating compartment 110 can be heated.

A user of the heating cooker 10 first puts the object to be heated into the heating compartment 110 in a state where the door portion 200 is opened, and closes the door portion 200. In this state, the heating cooker 10 heats the object to be heated by heating the airflow with the heat source and circulating the heated airflow inside the heating compartment 110. After heating the object to be heated, the user opens the door portion 200 and takes out the object to be heated from the heating compartment 110. A tray on which an object to be heated is placed may be provided inside the heating compartment 110.

As illustrated in FIGS. 1 and 2, the heating cooker 10 according to the present embodiment may include a lock mechanism 300. The lock mechanism 300 is provided, for example, in a space above the heating compartment 110 in the main body portion 100. For example, the lock mechanism 300 includes a frame 360 fixed to the upper surface of the upper outer wall of the heating compartment 110, and each unit such as a lock lever member 330 described later is supported by the frame 360. The lock mechanism 300 is a mechanism for bringing the door portion 200 into a locked state. Details of the lock mechanism 300 will be described later.

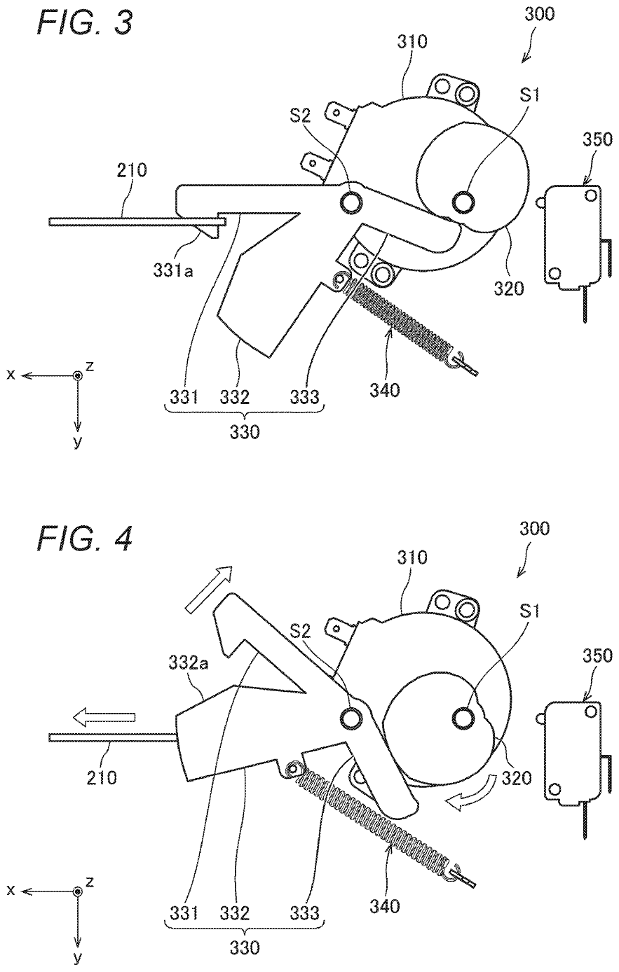

As illustrated in FIG. 1, the door portion 200 may include a door hook 210. The door hook 210 is, for example, a hook member (having a U-shape) provided with an opening in a rear portion when observed from the lateral direction (direction along the y-axis). For example, the main body portion 100 includes a wall portion 120 that covers a front surface of a space above the heating compartment 110. When the door portion 200 is closed, at least a part of the door hook 210 on the distal end side is inserted into a space above the heating compartment 110 through a through hole formed in the wall portion 120. When the door portion 200 is closed, the door hook 210 can be engaged with an engagement portion included in the lock mechanism 300 (an engagement portion 331a of the lock lever member 330 described later with reference to FIG. 3). Strictly speaking, it is assumed that the door hook 210 and the engagement portion 331a are engaged in the state of FIG. 1, but for the sake of convenience of the drawing, illustration of an engagement relationship is omitted in FIG. 1, and the engagement relationship will be described later with reference to FIG. 3 and subsequent drawings.

As described above, the heating cooker 10 according to the present embodiment includes the main body portion 100, the door portion 200 that has the door hook 210 and is movable with respect to the main body portion 100, and the lock mechanism 300. Then, the lock mechanism 300 sets the door portion 200 in the locked state using the engagement portion 331a. Furthermore, as will be described later, the lock mechanism 300 of the present embodiment is configured to automatically open the door portion 200 using the lock lever member 330 provided with the engagement portion 331a. For example, when the lock lever member 330 rotates in a predetermined direction to release the locked state, the engagement between the engagement portion 331a and the door hook 210 is released, and the other portion of the lock lever member 330 pushes out the door hook 210 forward (x-axis positive direction). In this manner, by providing the lock lever member 330 for locking the door portion 200 with a push-out function, the opening operation of the door portion 200 can be realized without adding a part. A detailed configuration of the lock mechanism 300 will be described later.

As described above, the door portion 200 of the present embodiment may be a vertically opening door that is rotatable with respect to the main body portion 100 on a horizontal rotation axis (in a narrow sense, a rotation axis realized by a hinge) provided in a lower portion of the door portion 200. In such a vertically opening door, the center of gravity of the door portion 200 is positioned above the rotation axis. Therefore, when the door portion 200 is pushed forward to some extent by the lock mechanism 300 and the center of gravity moves forward, a moment rotating around the rotation axis is generated in the door portion 200. That is, by using the vertically opening door, it is possible to realize the door portion 200 that can automatically shift to the open state even if no further force is applied after being pushed out by the lock mechanism 300.

### 2. CONFIGURATION EXAMPLE OF LOCK MECHANISM

FIG. 3 is a diagram illustrating a configuration example of the lock mechanism 300. The up-down direction (z axis), the front-rear direction (x axis), and the left-right direction (y axis) are similar to those in FIGS. 1 and 2. The lock mechanism 300 includes a motor 310, a cam 320, a lock lever member 330, a spring member 340 (spring), and a cam phase detection switch 350. However, the configuration of the lock mechanism 300 is not limited to the example of FIG. 3, and various modifications such as omitting a part of the configuration or adding another configuration can be made. For example, as will be described later as a modification, the cam phase detection switch 350 may be omitted. Although the frame 360 is omitted in FIG. 3, each configuration illustrated in FIG. 3 may be directly or indirectly supported by the frame 360. Being directly supported by the frame 360 means that the target configuration is supported (for example, fixed) by being in contact with the frame 360. Being indirectly supported by the frame 360 means that the target configuration is supported by being in contact with another configuration supported by the frame 360.

### Motor

The motor 310 is, for example, a synchronous motor capable of controlling the rotational speed by the frequency of the drive signal. The heating cooker 10 includes a control unit (control circuit) that controls a heat source and the like, and the control unit supplies a drive signal to the motor 310. However, a control unit (control circuit) for the lock mechanism 300 different from the control unit that controls the heat source and the like may be provided.

### Cam

The cam 320 is a cam that rotates in a predetermined direction around a fulcrum (rotation shaft) S1 by driving of the motor 310. FIG. 3 illustrates an example in which the cam 320 is a plate cam having a short diameter and a long diameter and rotating around the fulcrum S1, but a specific shape of the cam 320 can be variously modified. Hereinafter, an example in which the rotation direction of the cam 320 is a direction according to the forward rotation of the motor 310 (clockwise in FIG. 3) will be described, but the rotation directions of the motor 310 and the cam 320 are not limited thereto.

### Lock Lever Member

The lock lever member 330 is a member that rotates in a first direction around a fulcrum (rotation shaft) S2 with the rotation of the cam 320. The first direction is a rotation direction of the lock lever member 330 in a transition (FIG. 3 to FIG. 4 to be described later) from the lock position corresponding to the locked state to the unlock position corresponding to the unlocked state, and is, for example, clockwise. However, the first direction may be counterclockwise. In consideration of a transition from the unlock position to the lock position again (FIGS. 4, 5, and 6 to be described later), the lock lever member may rotate in a second direction opposite to the first direction. That is, in the present embodiment, “the lock lever member 330 rotates in the first direction around the fulcrum S2 along with the rotation of the cam 320.” means that the lock lever member 330 is rotatable at least in the first direction, and the rotation of the lock lever member 330 also in the second direction is not hindered.

As illustrated in FIG. 3, the lock lever member 330 includes a first portion 331 and a second portion 332. The first portion 331 is a member extending in a direction away from the fulcrum S2 (forward in the example of FIG. 3), and is provided with the engagement portion 331a that engages with the door hook 210. In the example of FIG. 3, the first portion 331 is a rod-shaped member in which the engagement portion 331a is provided at the distal end. The engagement portion 331a is a triangular protrusion that protrudes in a direction (rightward: the y-axis positive direction) intersecting the extending direction (forward: the x-axis positive direction) at the distal end portion of the first portion 331. The engagement portion 331a is engaged with the door hook 210 by being inserted into the opening of the door hook 210 from the left side, for example.

The second portion 332 extends in a direction away from the fulcrum S2 (an intermediate direction between the front and the right in the example of FIG. 3), and is provided at a position in the second direction opposite to the first direction with respect to the first portion 331. The second portion 332 pushes out the door hook 210 to cause the door portion 200 to perform an opening operation. Details will be described later.

Further, the lock lever member 330 may include a third portion 333. The third portion 333 extends in a direction away from the fulcrum S2 (an intermediate direction between the rear and the right in the example of FIG. 3), is provided at a position in the second direction opposite to the first direction with respect to the second portion 332, and is in contact with the cam 320. When the third portion functions as a cam follower, the lock lever member 330 rotates with the rotation of the cam 320. However, the second portion 332 may function as a cam follower by changing the shape of the lock lever member 330, and it is not essential to provide the third portion 333.

### Spring Member (Spring)

One end of the spring member 340 is locked to the lock lever member 330. Then, the spring member 340 applies a force in a direction of rotating in the second direction to the lock lever member 330.

For example, as illustrated in FIG. 3, one end of the spring member 340 may be locked to the second portion 332 of the lock lever member 330. However, the spring member 340 only needs to apply a force in the direction of rotating in the second direction to the lock lever member 330, and the specific locking position is not limited thereto. The other end of the spring member 340 is locked to the frame 360, for example, but the locking position of the other end can also be variously modified.

By providing the spring member 340, the lock lever member 330 is biased so that a part thereof comes into contact with the cam 320. When the third portion 333 is provided as the cam follower as described above, the lock lever member 330 is biased by the spring member 340 so that the third portion 333 and the cam 320 come into contact with each other. As a result, the rotation amount of the lock lever member 330 in the first direction can be controlled by the rotation of the cam 320. Although details will be described later, the lock lever member 330 may be at a position corresponding to the locked state in a state of being in contact with the portion corresponding to the short diameter of the cam 320 (lock position, see FIG. 3), and may rotate in the first direction as compared with the locked state in a state of being in contact with the portion corresponding to the long diameter of the cam 320 (unlock position, see FIG. 4 to be described later).

### Cam Phase Detection Switch

The cam phase detection switch 350 detects a phase (rotation phase) of the cam 320. Various configurations are known for the phase detection of the cam, and since the various configurations can be widely applied to the cam phase detection switch 350 of the present embodiment, the description of the specific configuration is omitted. When detecting that the phase of the cam 320 has reached a given set phase, the cam phase detection switch 350 outputs a stop signal for stopping the driving of the motor 310. For example, the lock mechanism 300 may include a circuit that supplies a stop signal to the motor 310 when the cam phase detection switch 350 is turned on. Alternatively, when detecting the set phase, the cam phase detection switch 350 may output a signal to a control unit (not illustrated), and the control unit may output a stop signal to the motor 310 based on the signal from the cam phase detection switch 350. In the present embodiment, “the cam phase detection switch outputs a signal for stopping the driving of the motor” includes both cases.

By providing the cam phase detection switch 350, the cam 320 can be stopped at an appropriate phase. For example, after the locked state is released by the lock lever member 330 and the door hook 210 is pushed out, the cam 320 and the lock lever member 330 can be moved to a predetermined position (specifically, returned to the initial position). Details will be described later.

Note that FIG. 3 illustrates an example of the position of the cam phase detection switch 350, and the positional relationship between the cam 320 and the cam phase detection switch 350 is not limited thereto. As will be described later as a modification, when the phase of the cam 320 can be controlled by controlling the rotation amount of the motor 310, the cam phase detection switch 350 may be omitted.

### 3. OPERATION EXAMPLE OF LOCK MECHANISM

Next, a flow of operation of the heating cooker 10 using the lock mechanism 300 will be described.

FIG. 3 described above is a view illustrating a locked state where the engagement portion 331a is engaged with the door hook 210. For example, in a case where there is no operation by the user, the lock mechanism 300 is stopped in the locked state illustrated in FIG. 3.

Then, when the user performs the opening operation of the door portion 200, the lock mechanism 300 starts the operation. For example, the heating cooker 10 of the present embodiment may include an operation unit (not illustrated) that detects the opening operation of the door portion 200. The operation unit is, for example, an operation panel provided on an upper front surface of the door portion 200, but a specific aspect thereof can be variously modified. When it is determined that the operation unit detects the opening operation, the motor 310 of the lock mechanism 300 starts the operation of rotating the cam 320. For example, when the opening operation is detected, the operation unit outputs a signal indicating the operation content to the control unit. The control unit starts driving of the motor 310 based on the signal from the operation unit.

FIG. 4 is a view illustrating a state where the lock lever member 330 is rotated in the first direction. As can be seen from the comparison between FIGS. 3 and 4, when the cam 320 rotates from the state where the third portion 333 is in contact with the short diameter of the cam 320, the diameter of the cam 320 in contact with the third portion 333 increases. The diameter of the cam 320 represents a distance from the fulcrum S1 of the cam 320 to a contact position with the cam follower. As a result, since the third portion 333 is pushed out in the first direction, the lock lever member 330 rotates in the first direction.

As illustrated in FIG. 4, when the lock lever member 330 rotates in the first direction from the locked state (FIG. 3) in which the engagement portion 331a engages with the door hook 210, the first portion 331 moves in a direction away from the door hook 210 to release the locked state. At this time, the second portion 332 comes into contact with the door hook 210 to push out the door portion 200 in the opening direction (front: the x-axis positive direction).

As described above, the second portion 332 is provided at a position in the direction opposite to the rotation direction of the lock lever member 330 with respect to the first portion 331 in which the engagement portion 331a is formed. Therefore, when the first portion 331 rotates in the first direction of disengaging, the second portion 332 approaches and comes into contact with the door hook 210. When the door hook 210 is pushed forward, the door portion 200 automatically continues the opening operation based on the positional relationship between the center of gravity and the rotation axis in the vertically opening door portion 200.

According to the method of the present embodiment, both the locking/unlocking of the door portion 200 and the opening operation of the door portion 200 can be realized by one lock lever member 330. As a result, there is an advantage that it is not necessary to add a member in order to realize two operations of locking/unlocking and the opening operation of the door portion 200. Furthermore, in the method of the present embodiment, the unlocking and the opening operation can be simultaneously realized by the rotation of the lock lever member 330. That is, since it is not necessary to perform separate control for the unlocking and the opening operation, there is an advantage that the control is easy.

The second portion 332 of the lock lever member 330 may have an inclined surface 332a whose thickness along the rotation direction decreases as the distance from the fulcrum S2 increases. In this case, when the lock lever member 330 rotates in the first direction from the locked state (transition from FIG. 3 to FIG. 4), the second portion 332 comes into contact with the door hook 210 such that the door hook 210 slides toward the distal end side of the second portion 332 along the inclined surface 332a. Therefore, when the lock lever member 330 rotates in the first direction, the door hook 210 can be smoothly pushed forward. However, the specific shape of the second portion 332 is not limited to this as long as the door hook 210 can be pushed forward. For example, as will be described later as a modification, the inclined surface may not be provided in the second portion 332.

The motor 310 of the present embodiment may continue the operation even after the door hook 210 is pushed out. Specifically, the motor 310 continues driving until a stop signal is input based on the detection result of the cam phase detection switch 350. In other words, the cam 320 continues to rotate until the rotation phase of the cam 320 reaches a given set phase.

Specifically, when detecting a phase indicating that the cam 320 has made one rotation, the cam phase detection switch 350 outputs a signal for stopping the driving of the motor 310. In other words, when detecting the phase corresponding to the initial position (position corresponding to the locked state, FIG. 3) of the cam 320, the cam phase detection switch 350 outputs a signal for stopping the driving of the motor 310.

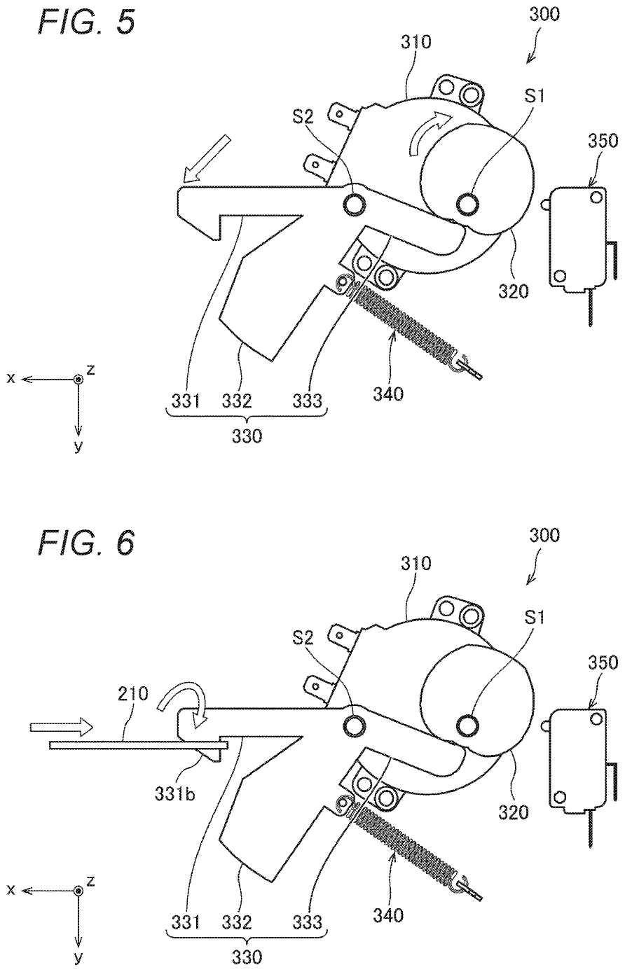

FIG. 5 is a diagram illustrating the lock mechanism 300 in a state where the motor 310 stops being driven on the basis of a signal from the cam phase detection switch 350. As illustrated in FIG. 5, the cam 320 stops in the same phase as that in FIG. 3 which is in the locked state. Accordingly, the lock lever member 330 also stops at the same position as in FIG. 3 in the locked state. In this way, when the opening operation is performed by the user, the state of the lock mechanism 300 can be returned to the state at the start of the operation after the unlocking and the opening operation of the door portion 200 are performed. When the lock mechanism 300 returns to the state illustrated in FIG. 5, thereafter, when the door portion 200 is moved to the closed position by the user (when the door portion 200 is moved to the upright state on the far side), it is possible to smoothly transition to the locked state.

FIG. 6 is a view for describing the lock mechanism in a case where the door portion 200 moves to the closed position in a state where the motor 310 of the lock mechanism 300 is stopped. In this case, as illustrated in FIG. 6, the door hook 210 enters rearward (x-axis negative direction) along the front-rear direction (the x axis) through a through hole formed in the wall portion 120 of the main body portion 100. When the distal end portion of the door hook 210 comes into contact with an inclined surface 331b of the engagement portion 331a, a force toward the left side (y-axis negative direction) of the left-right direction is applied to the engagement portion 331a, and the lock lever member 330 temporarily rotates in the first direction. When the distal end portion of the door hook 210 exceeds the rear end of the engagement portion 331a, the lock lever member 330 returns in the second direction by the force of the spring member 340, and the engagement portion 331a is inserted into the opening of the door hook 210, so that the locked state illustrated in FIG. 6 is obtained.

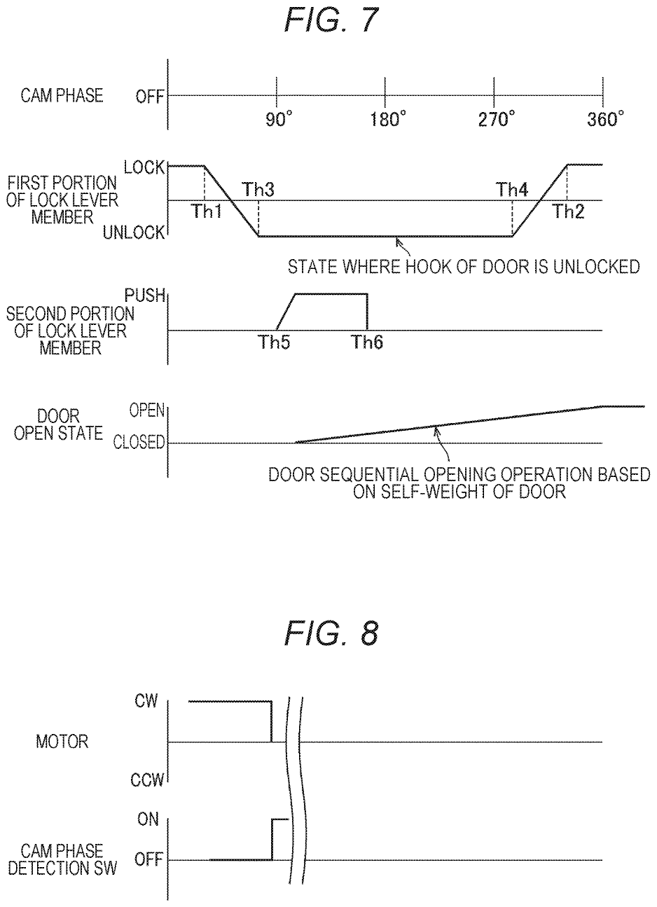

FIG. 7 is a timing chart for explaining the operation of each unit in the above sequence. The horizontal axis in FIG. 7 corresponds to the phase of the cam 320. The phase here is a rotation angle of the cam 320 around the fulcrum S1 accompanying the rotation of the motor 310, and the phase in the locked state (FIG. 3) is set to 0°. As described above, the phase of the cam 320 changes from 0° which is the starting point to the same phase, that is, to 360°. That is, in FIG. 7, the state of each unit changes from the left end of the horizontal axis toward the right side with the lapse of time.

FIG. 7 illustrates a state (position) of the first portion 331 of the lock lever member 330. The lock position (LOCK) is a position where the engagement portion 331a of the first portion 331 can stably engage with the door hook 210, and corresponds to, for example, a position illustrated in FIGS. 3, 5, and 6. As illustrated in FIG. 5, even when the engagement portion 331a of the first portion 331 is at the lock position, the door hook 210 is not engaged, that is, the door portion 200 is in the open state, so that the door portion 200 is allowed not to be in the locked state. The unlock position (UNLOCK) is a position where the engagement portion 331a of the first portion 331 cannot be engaged with the door hook 210, and corresponds to, for example, a position in a predetermined range including FIG. 4.

As illustrated in FIGS. 3, 5, and 6, when the phase of the cam 320 is equal to or less than a first threshold Th1 or equal to or greater than a second threshold Th2, the diameter from the fulcrum S1 of the cam 320 to the contact position of the cam follower is relatively short, so that the rotation amount of the lock lever member 330 in the first direction is small. That is, the movement amount of the engagement portion 331a is small, and the first portion 331 is at the lock position. On the other hand, when the phase of the cam 320 is greater than or equal to a third threshold Th3 and less than or equal to a fourth threshold Th4, the diameter from the fulcrum S1 of the cam 320 to the contact position of the cam follower is relatively long, and thus the rotation amount of the lock lever member 330 in the first direction is large. That is, the movement amount of the engagement portion 331a is large, and the first portion 331 is at the unlock position. Here, Th1<Th3<Th4<Th2.

In FIG. 7, an intermediate state between the lock position and the unlock position is allowed. The intermediate state indicates, for example, a state where a part of the engagement portion 331a is engaged with the door hook 210. For example, in the first portion 331, the phase of the cam 320 is between the first threshold Th1 and the third threshold Th3, and the first portion 331 transitions from the lock position to the unlock position. Similarly, in the first portion 331, the phase of the cam 320 is between the fourth threshold Th4 and the second threshold Th2, and the first portion 331 transitions from the unlock position to the lock position.

The second portion 332 of the lock lever member 330 starts to come into contact with the door hook 210 when the phase of the cam 320 becomes greater than or equal to a fifth threshold Th5 and the rotation amount of the lock lever member 330 becomes greater than or equal to a predetermined value. The second portion 332 pushes the door hook 210 forward when the phase of the cam 320 is within a range of a sixth threshold Th6 or less.

The door portion 200 transitions from the closed position to the open position by being pushed out by the second portion 332. The closed position is, for example, a state where the surface of the door portion 200 is perpendicular to the horizontal plane, and corresponds to the state illustrated in FIG. 1. The open position is a state where the door portion 200 is maximally opened, and is, for example, a state where a surface of the door portion 200 is parallel to a horizontal plane.

The door portion 200 starts to move from the closed position by being pushed out by the second portion 332. When the pushing amount by the second portion 332 exceeds a certain value, the opening operation is continued by its own weight without receiving a force in the pushing direction thereafter. FIG. 7 illustrates an example in which the door portion 200 finishes moving to the open position at the timing when the phase of the cam 320 becomes 360°, but the speed of the opening operation of the door portion 200 can be variously modified.

FIG. 8 is a timing chart illustrating a relationship between ON/OFF of the motor 310 and ON/OFF of the cam phase detection switch 350. The horizontal axis in FIG. 8 represents, for example, time. CW of the motor 310 represents forward rotation, and CCW represents reverse rotation. The state of 0 on the vertical axis of the motor 310 corresponds to the OFF state. The cam phase detection switch 350 is a switch that is turned on when the set phase is detected as described above.

As is clear from FIG. 8, when the cam phase detection switch 350 is turned on, the motor 310 shifts from ON to OFF. That is, when detecting that the set phase has been reached, the cam phase detection switch 350 shifts to the ON state and outputs a stop signal to the motor 310. As described above, the set phase is a phase in which the first portion 331 of the lock lever member 330 is at the initial position, that is, 0° (360°).

As described above, in the present embodiment, the position of each unit of the lock lever member 330 can be appropriately controlled in units of one rotation of the cam 320. As described above with reference to FIG. 6, when the door hook 210 is returned to the locked state, the state returns to the initial state (the state where the phase in FIG. 7 is 0)°. Therefore, even when the user performs the opening operation again, it is possible to perform the unlocking and the opening operation of the door portion 200 by the similar flow.

### 4. MODIFIED EXAMPLES

Some modifications will be described below.

An example in which the motor 310 is a synchronous motor and the phase of the cam 320 is controlled using the cam phase detection switch 350 has been described above. However, the method of the present embodiment is not limited thereto.

For example, the motor 310 according to the present embodiment may be a stepping motor capable of controlling a rotation angle. In this case, if the initial state is appropriately set, the subsequent phase of the cam 320 can be specified by the rotation angle of the motor 310. The motor 310 is controlled to rotate by a predetermined amount (specifically, 360°) when the opening operation by the user is detected. For example, when outputting a pulse signal to the motor 310 as a drive signal, the control unit may set the number of pulses so that the motor 310 rotates by a predetermined amount. In this way, it is possible to realize the above-described phase control of the cam 320 without providing the cam phase detection switch 350.

In FIGS. 3 to 6, an example in which the fulcrum (rotation shaft) S2 of the lock lever member 330 is provided at a position overlapping the door hook 210 in the front-rear direction has been described. In this case, in order to efficiently apply a forward force to the door hook 210, the second portion 332 may have an inclined surface 332a using FIG. 4. However, the method of the present embodiment is not limited thereto.

For example, the fulcrum S2 of the lock lever member 330 may be disposed at a position shifted in the left-right direction with respect to the door hook 210. Specifically, the fulcrum S2 may be disposed at a position shifted to the left (y-axis negative direction) with respect to the door hook 210. In this case, for example, even when the second portion 332 is a rod-shaped member whose thickness does not change even when separated from the fulcrum S2, the side surface of the second portion 332 comes into contact with the door hook 210 in a state of having a predetermined angle with respect to the x-axis. That is, even if the inclined surface is not provided in the second portion 332, the second portion 332 can be brought into contact with the door hook 210 in an inclined state with respect to the longitudinal direction (x-axis) of the door hook 210, so that the door hook 210 can be efficiently pushed forward by the rotation of the second portion 332. In addition, the heating cooker 10 of the present embodiment only needs to be able to push out the door portion 200 by the lock lever member 330 that locks the door portion 200, and the specific shape of the lock lever member 330 can be variously modified.

Although the present embodiment has been described in detail as described above, those skilled in the art will easily understand that many modifications can be made without departing from the novel matters and effects of the present embodiment. Therefore, all such modifications are included in the scope of the present disclosure. For example, a term described at least once in the specification or the drawings together with a different term that is broader or synonymous can be replaced with the different term anywhere in the specification or the drawings. All combinations of the present embodiment and modifications are also included in the scope of the present disclosure. Configurations, operations, and the like of the heating cooker, the lock mechanism, the lock lever member, and the like are not limited to those described in the present embodiment, and various modifications can be made.

What is claimed is:

1. A heating cooker comprising:
a main body portion;
a door portion having a door hook and being movable with respect to the main body portion;
and a lock mechanism including a cam, a motor that rotates the cam, and a lock lever member that rotates in a first direction about a fulcrum with rotation of the cam, wherein
the lock lever member includes:
a first portion extending in a direction away from the fulcrum and provided with an engagement portion that engages with the door hook; and
a second portion extending in a direction away from the fulcrum and provided at a position in a second direction opposite to the first direction with respect to the first portion, and
when the lock lever member rotates in the first direction from a locked state where the engagement portion engages with the door hook,
the first portion moves in a direction away from the door hook to release the locked state, and
the second portion comes into contact with the door hook to push out the door portion in an opening direction.

2. The heating cooker according to claim 1, wherein
the door portion is a vertically opening door that is rotatable with respect to the main body portion on a horizontal rotation axis provided in a lower portion of the door portion.

3. The heating cooker according to claim 1, wherein
the lock mechanism further includes a spring member whose one end is locked to the lock lever member, and
the spring member applies a force in a direction of rotating in the second direction to the lock lever member.

4. The heating cooker according to claim 3, wherein
the lock lever member is biased by the spring member such that a part of the lock lever member is in contact with the cam,
the lock lever member becomes a position corresponding to the locked state in a state of being in contact with a portion corresponding to a short diameter of the cam, and
the lock lever member rotates in the first direction as compared with the locked state in a state of being in contact with a portion corresponding to a long diameter of the cam.

5. The heating cooker according to claim 3, wherein
the one end of the spring member is locked to the second portion of the lock lever member.

6. The heating cooker according to claim 1, wherein
the lock mechanism includes a cam phase detection switch that detects a phase of the cam, and
the cam phase detection switch outputs a signal for stopping driving of the motor when detecting that the phase of the cam has reached a given set phase.

7. The heating cooker according to claim 6, further comprising:
an operation unit that detects an opening operation of the door portion, wherein
the motor starts an operation of rotating the cam in a case where the operation unit determines that the opening operation has been detected, and
the cam phase detection switch outputs a signal for stopping driving of the motor in a case where a phase indicating that the cam has made one rotation is detected.

8. The heating cooker according to claim 1, wherein
the second portion has an inclined surface whose thickness along a rotation direction becomes shorter as a distance from the fulcrum increases, and
the second portion comes into contact with the door hook so that the door hook slides toward a distal end side of the second portion along the inclined surface when the lock lever member rotates in the first direction from the locked state.

9. The heating cooker according to claim 1, wherein
the lock lever member includes a third portion that extends in a direction away from the fulcrum, is provided at a position in a second direction opposite to the first direction with respect to the second portion, and is in contact with the cam.
